(19) United States
(12) Patent Application Publication
(10) Pub. No.: US 2019/0215249 A1
(43) Pub. Date: Jul. 11, 2019

(54) Session Handling Using Conversation Ranking and Augmented Agents

(71) Applicant: XBrain, Inc., Menlo Park, CA (US)

(72) Inventors: Gregory Renard, Menlo Park, CA (US); Mathias Herbaux, San Mateo, CA (US); Aurelien Verla, Lille (FR); Audrey Duet, Santa Clara, CA (US); Anne Mervaillie, San Francisco, CA (US); Gregory Senay, Santa Clara, CA (US)

(21) Appl. No.: 16/235,826

(22) Filed: Dec. 28, 2018

Related U.S. Application Data
(60) Provisional application No. 62/612,186, filed on Dec. 29, 2017.

(51) Int. Cl. H04L 12/24; H04L 12/58; G06F 3/0484; H04L 29/06; G06F 17/27

(52) U.S. Cl. CPC H04L 41/22; H04L 51/02; G06N 20/00; H04L 65/1066; G06F 17/2765; G06F 3/0484

(57) ABSTRACT

A system and method to receive user input from a human user in a communication session between the human user and a first machine; autonomously determine a sentiment metric of the user input from the human user based on one or more sentiment criteria, wherein the sentiment metric represents an attitude of the human user; autonomously determine a quality metric associated with the communication session; autonomously rank the communication session between human user and first machine based on one or more of the sentiment metric and the quality metric; and determine based on the ranking, to recommend human agent intervention in the communication session between the human user and the first machine.

### CROSS-REFERENCE TO RELATED APPLICATIONS

This application claims priority under 35 U.S.C. § 119(e) to U.S. Provisional Patent Application No. 62/612,186, filed on Dec. 29, 2017, entitled “Session Handling Using Conversation Ranking and Augmented Agents,” which is herein incorporated by reference in its entirety.

### BACKGROUND

A first problem is that human agents are expensive to pay and difficult to retain, especially when many are needed for customer support. A second problem is that artificial intelligence (AI), e.g., chatbot systems may not always understand a user's intent, which may frustrate users. What is needed is a system that reduces or eliminates these problems.

### SUMMARY

According to one innovative aspect of the subject matter described in this disclosure, one or more processors; and a memory storing instructions that, when executed by the one or more processors, cause the system to: receive user input from a human user in a communication session between the human user and a first machine; autonomously determine a sentiment metric of the user input from the human user based on one or more sentiment criteria, wherein the sentiment metric represents an attitude of the human user; autonomously determine a quality metric associated with the communication session; autonomously rank the communication session between human user and first machine based on one or more of the sentiment metric and the quality metric; and determine based on the ranking, to recommend human agent intervention in the communication session between the human user and the first machine.

In general, another innovative aspect of the subject matter described in this disclosure may be embodied in methods that include receiving, using one or more processors, user input from a human user in a communication session between the human user and a first machine; autonomously determining, using the one or more processors, a sentiment metric of the user input from the human user based on one or more sentiment criteria, wherein the sentiment metric represents an attitude of the human user; autonomously determining, using the one or more processors, a quality metric associated with the communication session; autonomously ranking, using the one or more processors, the communication session between human user and first machine based on one or more of the sentiment metric and the quality metric; and determining, using the one or more processors, based on the ranking, to recommend human agent intervention in the communication session between the human user and the first machine.

Other implementations of one or more of these aspects include corresponding systems, apparatus, and computer programs, configured to perform the actions of the methods, encoded on computer storage devices.

For instance, the features include: the first machine includes an artificial intelligence, or a virtual assistant, or a chatbot.

For instance, the features include: the sentiment metric of the user input is determined based on one or more of a single human user input in the communication session, a set of multiple human user inputs during the communication session, and a trend of sentiment during the communication session.

For instance, the features include: wherein the sentiment metric is determined based on one or more of presence of offensive language, emojis usage, punctuation usage, font style, use of letter capitalization, vocal analysis, explicit request by the human user for a human, spelling mistakes, rapidity of response, repetition of input by the human user.

For instance, the features include: the quality metric is a numeric value associated with one or more of a confidence of the first machine in an intent of the human user, as determined by the first machine, and a confidence of the first machine in an answer determined in response to the user input and the intent of the human user as determined by the first machine.

For instance, the features include: determination of the sentiment metric, the quality metric, and the ranking are performed responsive to receipt of the user input from the human user, and re-performed after a subsequent input is received from the human user.

For instance, the operations further include: visually indicating within a graphical user interface that intervention by a human agent is recommended for the communication session based on the ranking, the graphical user interface presented to the human agent; and receiving input from the human agent requesting intervention in the communication session.

For instance, the features include: the graphical user interface includes a plurality of session indicators including a first session indicator associated with the communication session.

For instance, the operations further include: receiving input from a human agent requesting assistance from a second machine; initiating a second communication session with the second machine; and providing a graphical user interface including a first portion displaying input of the human user, first machine, and human agent, and a second portion displaying a communication session between the human agent and the second machine.

For instance, the features include: receiving a request, on behalf of the human agent, to end intervention by the human agent, wherein, responsive to receiving the request to end intervention by the human agent, the communication session continues between the human user and the first machine.

The features and advantages described herein are not all-inclusive and many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram illustrating an example system for session handling according to one embodiment.

FIG. 2 is a block diagram illustrating an example of a session server according to one embodiment.

FIG. 3 is a block diagram illustrating an example of a session engine according to one embodiment.

FIG. 4 is a block diagram illustrating an example of session handling using conversation ranking and augmented agents according to one embodiment.

FIG. 5 is a block diagram illustrating an example of conversation ranking according to one embodiment.

FIG. 6 is a diagram describing an example of augmented session handling according to one embodiment.

FIG. 7 depicts various example graphs associated with the system according to one embodiment.

FIGS. 8a-o illustrate example user interfaces presented to a human agent by the system according to one embodiment.

### DETAILED DESCRIPTION

A previously noted, human agents are expensive to pay and difficult to retain, especially when many are needed for customer support. Additionally, AI, e.g., chatbot systems may not always understand a user's (e.g. a customer's) intent, which may frustrate users. Therefore, the system and methods described herein leverage AI, e.g., chatbots, but allows human intervention thereby creating one or more of increased throughput of sessions, increased sessions per person/shift of human agents, increased customer satisfaction, increased agent satisfaction, lower operating costs for the company, and extended service hours to customers.

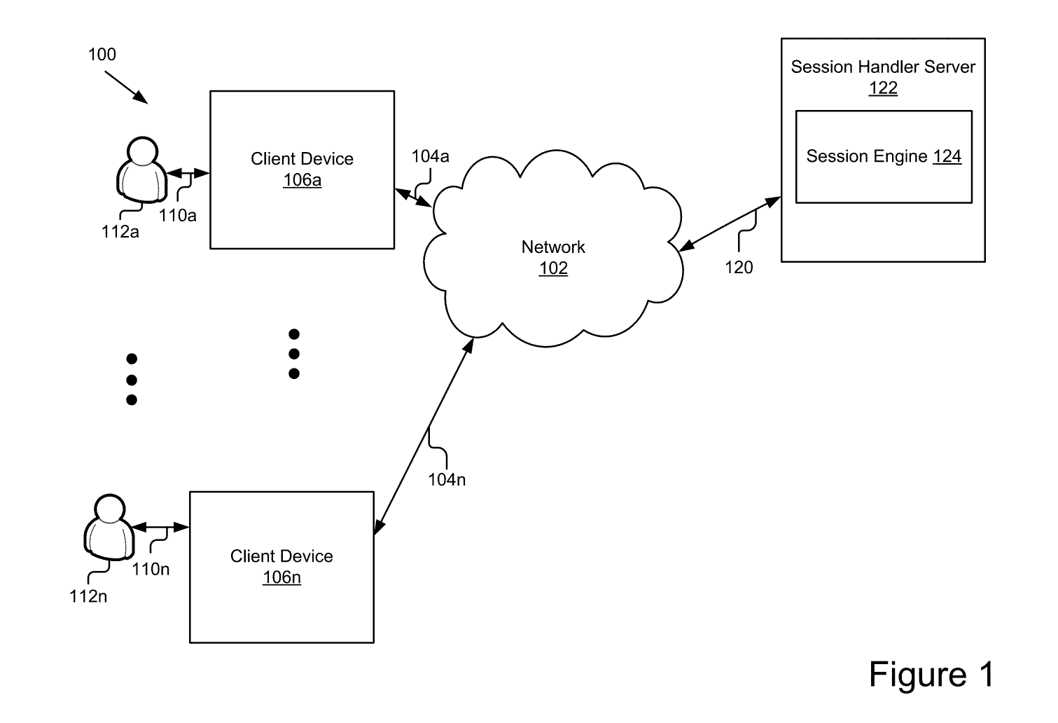

FIG. 1 is a block diagram illustrating an example system 100 for session handling according to one embodiment. The illustrated system 100 includes client devices 106a . . . 106n and a session handler server 122, which are communicatively coupled via a network 102 for interaction with one another. For example, the client devices 106a . . . 106n may be respectively coupled to the network 102 via signal lines 104a . . . 104n and may be accessed by users 112a . . . 112n (also referred to individually and collectively as user 112) as illustrated by lines 110a . . . 110n. The session handler server 122 may be coupled to the network 102 via signal line 120. The use of the nomenclature “a” and “n” in the reference numbers indicates that any number of those elements having that nomenclature may be included in the system 100.

The network 102 may include any number of networks and/or network types. For example, the network 102 may include, but is not limited to, one or more local area networks (LANs), wide area networks (WANs) (e.g., the Internet), virtual private networks (VPNs), mobile networks (e.g., the cellular network), wireless wide area network (WWANs), Wi-Fi networks, WiMAX® networks, Bluetooth® communication networks, peer-to-peer networks, other interconnected data paths across which multiple devices may communicate, various combinations thereof, etc. Data transmitted by the network 102 may include packetized data (e.g., Internet Protocol (IP) data packets) that is routed to designated computing devices coupled to the network 102. In some implementations, the network 102 may include a combination of wired and wireless (e.g., terrestrial or satellite-based transceivers) networking software and/or hardware that interconnects the computing devices of the system 100. For example, the network 102 may include packet-switching devices that route the data packets to the various computing devices based on information included in a header of the data packets.

The data exchanged over the network 102 can be represented using technologies and/or formats including the hypertext markup language (HTML), the extensible markup language (XML), JavaScript Object Notation (JSON), Comma Separated Values (CSV), Java DataBase Connectivity (JDBC), Open DataBase Connectivity (ODBC), etc. In addition, all or some of links can be encrypted using encryption technologies, for example, the secure sockets layer (SSL), Secure HTTP (HTTPS) and/or virtual private networks (VPNs) or Internet Protocol security (IPsec). In another embodiment, the entities can use custom and/or dedicated data communications technologies instead of, or in addition to, the ones described above. Depending upon the embodiment, the network 102 can also include links to other networks. Additionally, the data exchanged over network 102 may be compressed.

The client devices 106a . . . 106n (also referred to individually and collectively as client device 106) are computing devices having data processing and communication capabilities. While FIG. 1 illustrates two client devices 106, the present specification applies to any system architecture having one or more client devices 106. In some embodiments, a client device 106 may include a processor (e.g., virtual, physical, etc.), a memory, a power source, a network interface, and/or other software and/or hardware components, such as a display, graphics processor, wireless transceivers, keyboard, speakers, camera, sensors, firmware, operating systems, drivers, various physical connection interfaces (e.g., USB, HDMI, etc.). The client devices 106a . . . 106n may couple to and communicate with one another and the other entities of the system 100 via the network 102 using a wireless and/or wired connection. In one embodiment, a user 112a may be a customer and interact with user 112n who is a human customer service agent through the session handler server 122, as described below, using their respective client devices 106.

Examples of client devices 106 may include, but are not limited to, automobiles, robots, mobile phones (e.g., feature phones, smart phones, etc.), tablets, laptops, desktops, netbooks, server appliances, servers, virtual machines, TVs, set-top boxes, media streaming devices, portable media players, navigation devices, personal digital assistants, etc. While two or more client devices 106 are depicted in FIG. 1, the system 100 may include any number of client devices 106. In addition, the client devices 106a . . . 106n may be the same or different types of computing devices. For example, in one embodiment, the client device 106a is an automobile and client device 106n is a mobile phone.

It should be understood that the system 100 illustrated in FIG. 1 is representative of an example system according to one embodiment and that a variety of different system environments and configurations are contemplated and are within the scope of the present disclosure. For instance, various functionality may be moved from a server to a client, or vice versa and some implementations may include additional or fewer computing devices, servers, and/or networks, and may implement various functionality client or server-side. Further, various entities of the system 100 may be integrated into to a single computing device or system or divided among additional computing devices or systems, etc. Furthermore, the system 100 may include automatic speech recognition (ASR) functionality (not shown), which may enable verbal/voice input (e.g. via VOIP) and/or requests, and text-to-speech (TTS) functionality, which may enable, verbal output by the system to a trainer, agent, customer, or end user. However, it should be recognized that inputs may use text and the system may provide outputs via text.

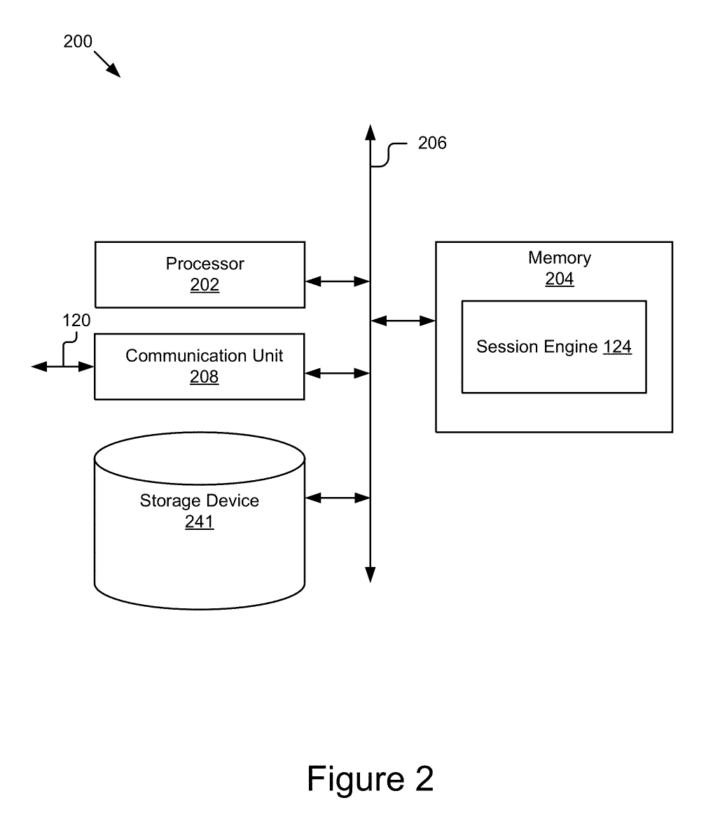

FIG. 2 is a block diagram of an example session handler server 122 according to one embodiment. The session handler server 122, as illustrated, may include a processor 202, a memory 204, a communication unit 208, and a storage device 241, which may be communicatively coupled by a communications bus 206. The session handler server 122 depicted in FIG. 2 is provided by way of example and it should be understood that it may take other forms and include additional or fewer components without departing from the scope of the present disclosure. For example, while not shown, the session handler server 122 may include input and output devices (e.g., a display, a keyboard, a mouse, touch screen, speakers, etc.), various operating systems, sensors, additional processors, and other physical configurations. Additionally, it should be understood that the computer architecture depicted in FIG. 2 and described herein can be applied to multiple entities in the system 100 with various modifications, including, for example, a client device 106 (e.g. by omitting the session engine 124).

The processor 202 comprises an arithmetic logic unit, a microprocessor, a general purpose controller, a field programmable gate array (FPGA), an application specific integrated circuit (ASIC), or some other processor array, or some combination thereof to execute software instructions by performing various input, logical, and/or mathematical operations to provide the features and functionality described herein. The processor 202 may execute code, routines and software instructions by performing various input/output, logical, and/or mathematical operations. The processor 202 have various computing architectures to process data signals including, for example, a complex instruction set computer (CISC) architecture, a reduced instruction set computer (RISC) architecture, and/or an architecture implementing a combination of instruction sets. The processor 202 may be physical and/or virtual, and may include a single core or plurality of processing units and/or cores. In some implementations, the processor 202 may be capable of generating and providing electronic display signals to a display device (not shown), supporting the display of images, capturing and transmitting images, performing complex tasks including various types of feature extraction and sampling, etc. In some implementations, the processor 202 may be coupled to the memory 204 via the bus 206 to access data and instructions therefrom and store data therein. The bus 206 may couple the processor 202 to the other components of the session handler server 122 including, for example, the memory 204, communication unit 208, and the storage device 241.

The memory 204 may store and provide access to data to the other components of the session handler server 122. In some implementations, the memory 204 may store instructions and/or data that may be executed by the processor 202. For example, as depicted, the memory 204 may store one or more engines such as the session engine 124. The memory 204 is also capable of storing other instructions and data, including, for example, an operating system, hardware drivers, software applications, databases, etc. The memory 204 may be coupled to the bus 206 for communication with the processor 202 and the other components of the session handler server 122.

The memory 204 includes a non-transitory computer-usable (e.g., readable, writeable, etc.) medium, which can be any apparatus or device that can contain, store, communicate, propagate or transport instructions, data, computer programs, software, code, routines, etc., for processing by or in connection with the processor 202. In some implementations, the memory 204 may include one or more of volatile memory and non-volatile memory. For example, the memory 204 may include, but is not limited, to one or more of a dynamic random access memory (DRAM) device, a static random access memory (SRAM) device, a discrete memory device (e.g., a PROM, FPROM, ROM), a hard disk drive, an optical disk drive (CD, DVD, Blue-ray™, etc.). It should be understood that the memory 204 may be a single device or may include multiple types of devices and configurations.

The bus 206 can include a communication bus for transferring data between components of the session handler server 122 or between computing devices 106/122, a network bus system including the network 102 or portions thereof, a processor mesh, a combination thereof, etc. In some implementations, the session engine 124, its sub-components and various software operating on the session handler server 122 (e.g., an operating system, device drivers, etc.) may cooperate and communicate via a software communication mechanism implemented in association with the bus 206. The software communication mechanism can include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSL, HTTPS, etc.).

The communication unit 208 may include one or more interface devices (I/F) for wired and/or wireless connectivity with the network 102. For instance, the communication unit 208 may include, but is not limited to, CAT-type interfaces; wireless transceivers for sending and receiving signals using radio transceivers (4G, 3G, 2G, etc.) for communication with the mobile network 103, and radio transceivers for and close-proximity (e.g., Bluetooth®, NFC, etc.) connectivity, etc.; USB interfaces; various combinations thereof; etc. In some implementations, the communication unit 208 can link the processor 202 to the network 102, which may in turn be coupled to other processing systems. The communication unit 208 can provide other connections to the network 102 and to other entities of the system 100 using various standard network communication protocols, including, for example, those discussed elsewhere herein.

The storage device 241 is an information source for storing and providing access to data. In some implementations, the storage device 241 may be coupled to the components 202, 204, and 208 of the computing device via the bus 206 to receive and provide access to data. Examples of data include, but at not limited to customer information, data and repositories used by chatbots, etc.

The storage device 241 may be included in the session handler server 122 and/or a storage system distinct from but coupled to or accessible by the session handler server 122. The storage device 241 can include one or more non-transitory computer-readable mediums for storing the data. In some implementations, the storage device 241 may be incorporated with the memory 204 or may be distinct therefrom. In some implementations, the storage device 241 may include a database management system (DBMS) operable on the session handler server 122. For example, the DBMS may include a structured query language (SQL) DBMS, a NoSQL DBMS, various combinations thereof, etc. In some instances, the DBMS may store data in multi-dimensional tables comprised of rows and columns, and manipulate, i.e., insert, query, update and/or delete, rows of data using programmatic operations.

As mentioned above, the session handler server 122 may include other and/or fewer components. Examples of other components may include a display, an input device, a sensor, etc. (not shown). In one embodiment, the computing device includes a display. The display may include any display device, monitor or screen, including, for example, an organic light-emitting diode (OLED) display, a liquid crystal display (LCD), etc. In some implementations, the display may be a touch-screen display capable of receiving input from a stylus, one or more fingers of a user 112, etc. For example, the display may be a capacitive touch-screen display capable of detecting and interpreting multiple points of contact with the display surface.

The input device (not shown) may include any device for inputting information into the session handler server 122. In some implementations, the input device may include one or more peripheral devices. For example, the input device may include a keyboard (e.g., a QWERTY keyboard or keyboard in any other language), a pointing device (e.g., a mouse or touchpad), microphone, an image/video capture device (e.g., camera), etc.

In one embodiment, a client device may include similar components 202/204/206/208/241 to the session handler server 122. In one embodiment, the client device 106 and/or the session handler server 122 includes a microphone for receiving voice input and speakers for facilitating text-to-speech (TTS). In some implementations, the input device may include a touch-screen display capable of receiving input from the one or more fingers of the user 112. For example, the user 112 could interact with an emulated (i.e., virtual or soft) keyboard displayed on the touch-screen display by using fingers to contacting the display in the keyboard regions.

### Example Session Engine 124

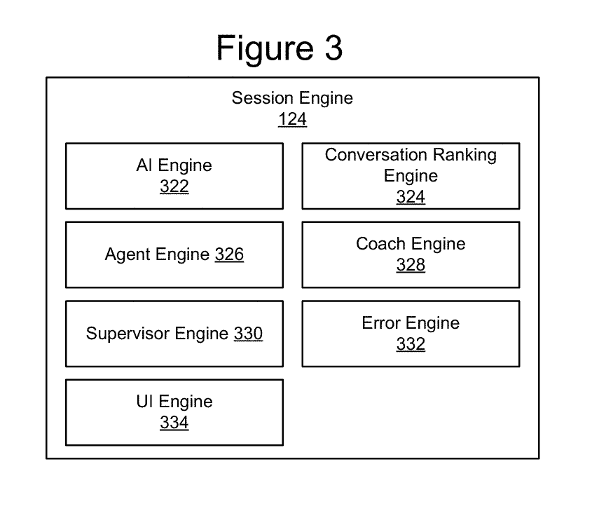

Referring now to FIG. 3, a block diagram of an example session engine 124 is illustrated according to one embodiment. In the illustrated embodiment, the session engine 124 includes an AI engine 322, a conversation ranking engine 324, an agent engine 326, coach engine 328, supervisor engine 330, error engine 332 and UI engine 334.

The engines 322/324/326/328/330/332/334 of FIG. 3 are adapted for cooperation and communication with the processor 202 and, depending on the engine, other components of the session engine 124 or the system 100. In some embodiments, an engine may be a set of instructions executable by the processor 202, e.g., stored in the memory 204 and accessible and executable by the processor 202.

The AI engine 322 provides AI functionality to one or more sessions in one or more human languages (e.g. English, French, etc.). In one embodiment, the AI engine 322 creates a session and answers customer questions in the session. Depending on the embodiment, the session may be text based (e.g. instant messenger chat based or e-mail based) or voice based (e.g. phone call). Depending on the embodiment, the customer may be a human user (e.g. user 112a interacting with the system via client device 106a) or a machine user (e.g. client device 106a or some component thereof).

In some embodiments, the AI engine 322 uses automatic speech recognition and natural language processing to determine a customer's intent (i.e. question) and uses an algorithm derived using machine learning to determine an appropriate response. In some embodiments, the AI engine 322 determines a customer's intent based on an intent with the highest confidence. For example, the AI engine 322 determines, using natural language processing, that the most likely intents are to check the customer's current balance and check the customer's credit limit, and selects the intent with the greater confidence, which may be statistically generated. Also for example, the AI engine 322 determines and selects a response with the greater confidence, which may be statistically generated (e.g., the AI engine 322 selects to provide the credit limit for the primary card holder and not that of an authorized user).

In some embodiments, when a customer attempts to reach customer service, a session is begun by the AI engine 322 and the AI engine 322 (occasionally referred to herein as a chatbot) attempts to handle the session, e.g., by answering the customer's question or executing the action(s) desired by the customer.

In some embodiments, there is more than one AI engine 322. Depending on the embodiment, there may be different instances of the same AI engine 322 (i.e. multiple instances of the same chatbot) or different AI engines 322 (i.e. different chatbots, e.g., a Samsung customer service chatbot and Wells Fargo customer service chatbot).

In the depicted implementation, the session handler server 122 includes an instance of an AI engine 322. Depending on the embodiment, the AI engine 322 may be on-board, off-board or a combination thereof. For example, in one embodiment, the AI engine 322 is on-board on the client device 106. In another example, in one embodiment, the AI engine 322 is off-board on the session handler server 122 (or on a separate AI server (not shown)). In yet another example, AI engine 322 operates at both the client device 106 (not shown) and the session handler server 122 by the AI engine 322.

Depending on the embodiment and circumstances, the session may be between a machine (e.g. AI, chatbot, digital assistant, etc.) and a human (e.g. a customer) or two humans (e.g. between a customer and a human customer service agent).

It should be recognized that AI engines 322 are not infallible. For example, the AI engine 322 may misidentify a user's intent and/or may not be able to provide an answer. Therefore, there are circumstances where the session between a customer and the AI engine 322 (e.g. AI, chatbot, digital assistant) may become unhelpful to the customer and a source of frustration, which is a technical problem. The conversation ranking engine 324 may provide a technical solution, at least in part, by providing criteria for machine identification (e.g. via ranking) of problematic sessions, which may be brought to the attention of a human (e.g. customer service agent) who may intervene in the session.

The conversation ranking engine 324 monitors one or more sessions and ranks the one or more sessions. In some embodiments, the conversation ranking engine 324 ranks a session relative to other on-going sessions. In some embodiments, the conversation ranking engine 324 ranks a session relative to sessions including on-going sessions and historic sessions. In some embodiments, the rank assigned to the session is indicative of whether it is advisable that a human agent, occasionally referred to herein as an “agent,” should intervene and take over a machine's (e.g. chatbot's) role in the session between a user and the machine (e.g. chatbot).

In one embodiment, the conversation ranking engine 324 ranks a session based on one or more of the quality of the AI engine's 322 answers and the sentiment of the session. In one embodiment, the “quality” of the conversation may be determined by the conversation ranking engine 324 using one or more of the following, which may be referred to herein as “qualitative criteria”:
The confidence of the AI engine 322 in the user's (e.g. customer's) intent. For example, when the AI engine 322 is not confident in the accuracy of what it believes the customer is asking, the conversation ranking engine 324 may affect the ranking in favor of intervention by a user (e.g. a customer service agent). This may be based on an average over the course of the session (e.g. a whole-session average confidence) or a portion of the session (e.g. there has been a series of low-confidence intents, which satisfies a threshold number of low-confidence intents, and argues in favor of human agent intervention, so the conversation ranking engine 324 adjusts the ranking accordingly). Based on different types of algorithm, as mentioned above to compute the confidence, the system 100 may provide the confidence as a percentage or other numerical value. Based on the final confidence score, it may decide to activate the intent expected (e.g. when the confidence is over 80%) or to create a dialog between the user and the machine to ask more precisions (i.e. follow-up questions to better discern the expected intent). When the confidence satisfies a first threshold (e.g. when between 60 and 79.9% accuracy for confidence), the system 100 may automatically activate the session handling by a human (e.g. an agent), or, when another threshold is satisfied (e.g. when under 60% of accuracy for the confidence), the system 100 enters the session in a waiting list to be taken over by a human (e.g. an agent). It should be noted that the thresholds provided are merely examples and others may be used without departing from the disclosure herein. In one embodiment, the thresholds may be parameters in the system 100 that may be defined.
The confidence of the AI engine's 322 answer(s). For example, if the AI engine 322 is not confident in the accuracy of an answer, it may affect the ranking in favor of intervention by a user. Based on different types of algorithm, the system 100 may provide the confidence as a percentage or other numerical value. In some embodiments, the confidence in the AI engine's answers is based on an average over the course of the session. Alternatively, the confidence in the AI engine's answers may be based on a portion of the session (e.g. there has been a series of low-confidence answers, which satisfies a threshold number of low-confidence answers, and argues in favor of human agent intervention, so the conversation ranking engine 324 adjusts the ranking accordingly).
The continuity of the conversation, e.g., whether the conversation is stuck in a loop or the customer is repeating himself/herself. For example, the conversation ranking engine 324 determines whether the conversation in a session is looping and adjusts that rank of that session. In another example, the conversation ranking engine 324 determines whether the user (e.g. customer) is repeating himself/herself and adjusts the rank of the session.
Feedback received, e.g., at the end of the conversation. For example, the response to a survey at the end of a session indicating that the service provided was unhelpful may indicate that a human should intervene and the conversation ranking engine 324 uses such feedback in determining the sessions ranking.
An error is detected in the detected intent.

In some embodiments, one or more of the foregoing qualitative criteria are used to generate a quality metric, which is used by the conversation ranking engine 324 alone, or in combination with a sentiment metric (depending on the embodiment), to rank the conversation.

In one embodiment, the “sentiment” of the conversation may be evaluated by the conversation ranking engine 324 using machine-based sentiment analysis of each interaction. In one embodiment, sentiment analysis refers to the use of natural language processing, text analysis, computational linguistics and biometrics (e.g. voice) to systematically identify, extract and study affective states and subjective information, e.g., to determine the attitude of a speaker, writer or other subject. Depending on the embodiment, the attitude may be one or more of a judgment or evaluation (as in appraisal theory), affective state (i.e., the emotional state of the author or speaker), or the intended emotional communication (i.e., the emotional effect intended by the author or interlocutor). Depending on the embodiment, the conversation ranking engine 324 uses one or more of the following, which may be referred to as “sentiment criteria,” to evaluate the “sentiment” of the session and rank the session:
Average (e.g. arithmetic or harmonic) sentiment analysis over all interactions in the conversation/session, which may serve as a forecast of the conversation or as a dialogue atmosphere.
Sentiment analysis trend of the conversation, e.g., positive to negative, neutral to negative, the opposite, etc.
Offensive language usage, e.g., using keyword detection based on offenses n-gram dictionary.
Detection of emojis, which may balance the trend of conversation (e.g. a winking, tongue sticking out or smiling emoji may indicate use of an otherwise offensive term is being used playfully or in jest).
Punctuation (e.g. use of exclamation point may be indicative of anger or frustration)
Font style (e.g. use of bold, underlining or italics may be indicative of anger or frustration).
Letter capitalization (e.g. use of all caps may be indicative of anger or frustration).
Rapidity of response (e.g. immediate answers may be indicative of urgency)
Explicit request for a customer service agent (human).
Vocal analysis (e.g. to detect stress, urgency, anger, frustration, etc. in the customer's voice).
Number of utterances, words, tokens or a combination thereof.
Context history.
Spelling mistakes.

In some embodiments, one or more of the foregoing sentiment criteria are used to generate a sentiment metric, which is used by the conversation ranking engine 324 alone, or in combination with a sentiment metric (depending on the embodiment), to rank the conversation.

The conversation ranking engine 324 uses one or more of the qualitative criteria and the sentiment criteria (e.g. via sentiment analysis) to determine a rank for a session (e.g. based on the determined metrics). For example, the conversation ranking engine 324 uses the qualitative criteria and the sentiment criteria to determine a value used to determine a session's rank. The value used to determine the session's rank may vary depending on the embodiment. For example, the value may be a weighted average calculated using the qualitative criteria and sentiment criteria. In some embodiments, the weight each criterion is assigned may be dynamic (e.g. may be set by a team of users, may vary over time and be assigned using machine learning, etc.).

Depending on the embodiment, the rank assigned by the conversation ranking engine 324 may vary in form. For example, in some embodiments, the conversation ranking engine 324 may assign a numerical rank (e.g. in order of most likely to need agent intervention to least likely, or least likely to need agent intervention to most likely). In another example, in some embodiments, the conversation ranking engine 324 may assign a categorical rank (e.g. positive, negative, and neutral, where negative ranked sessions are likely in need of agent intervention).

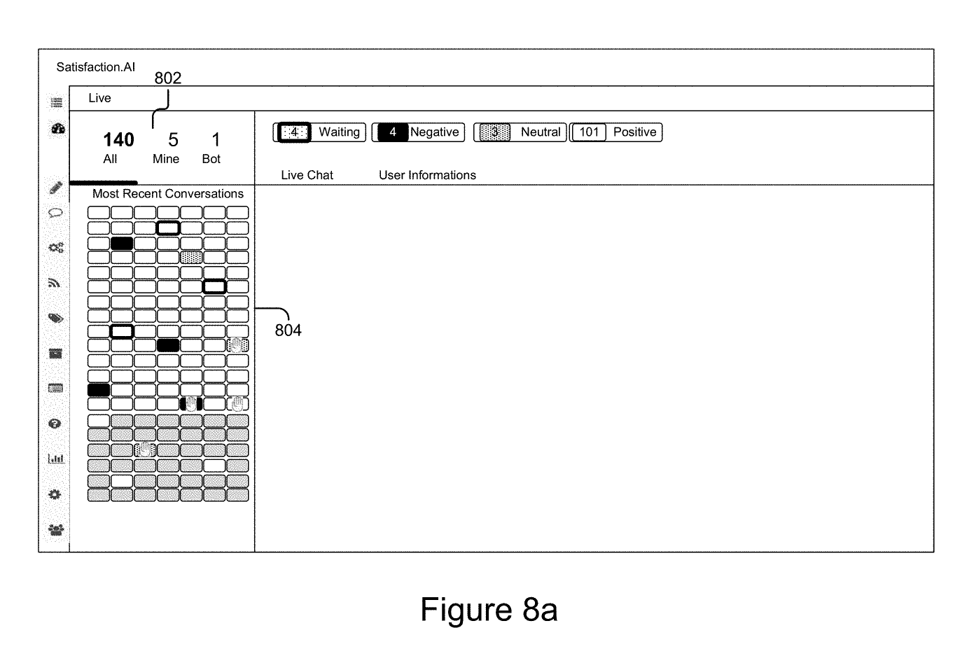

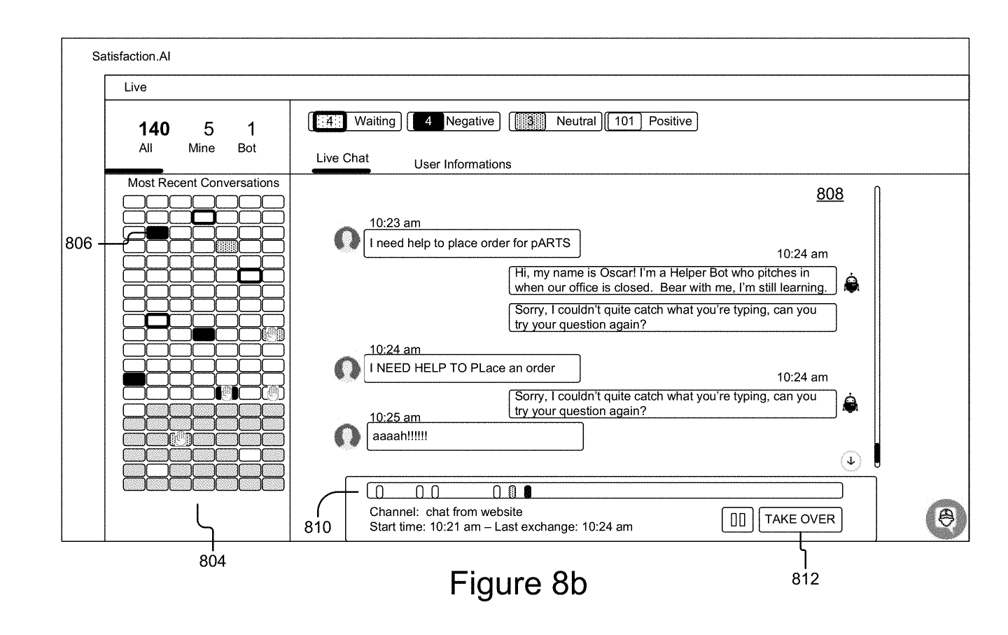

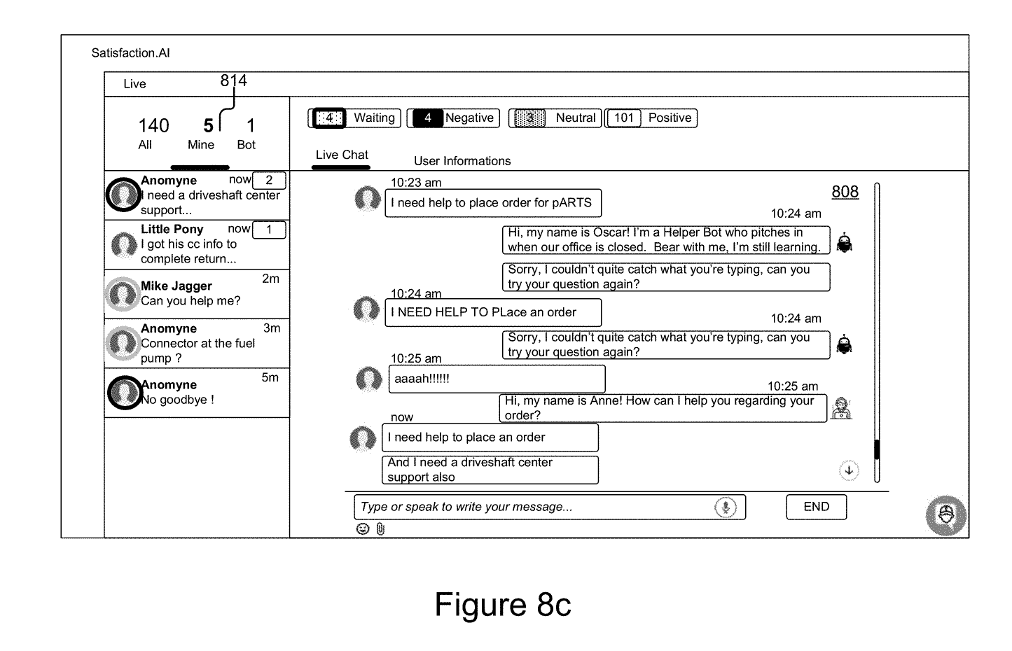

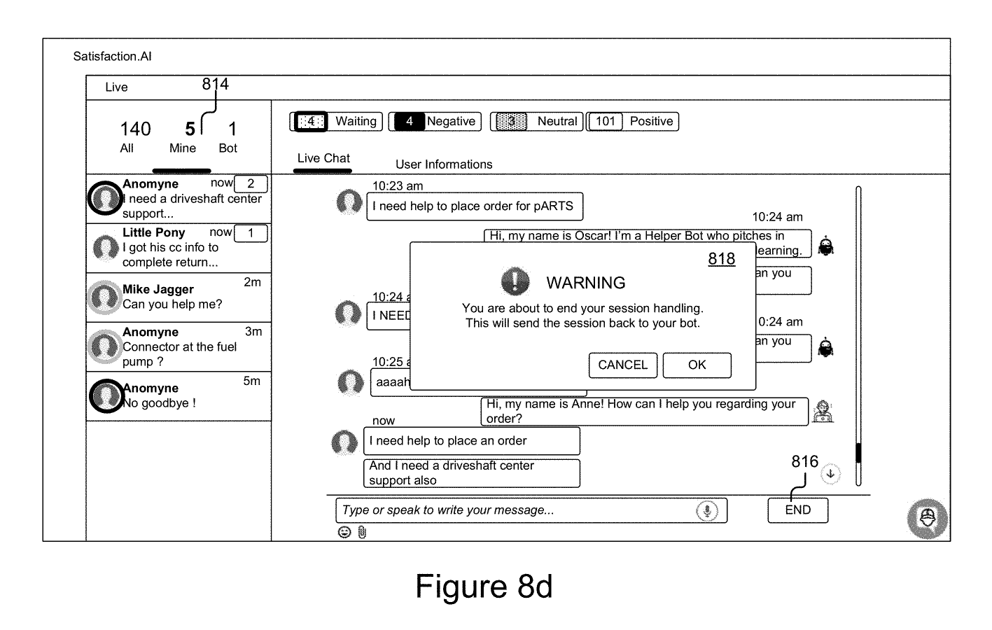

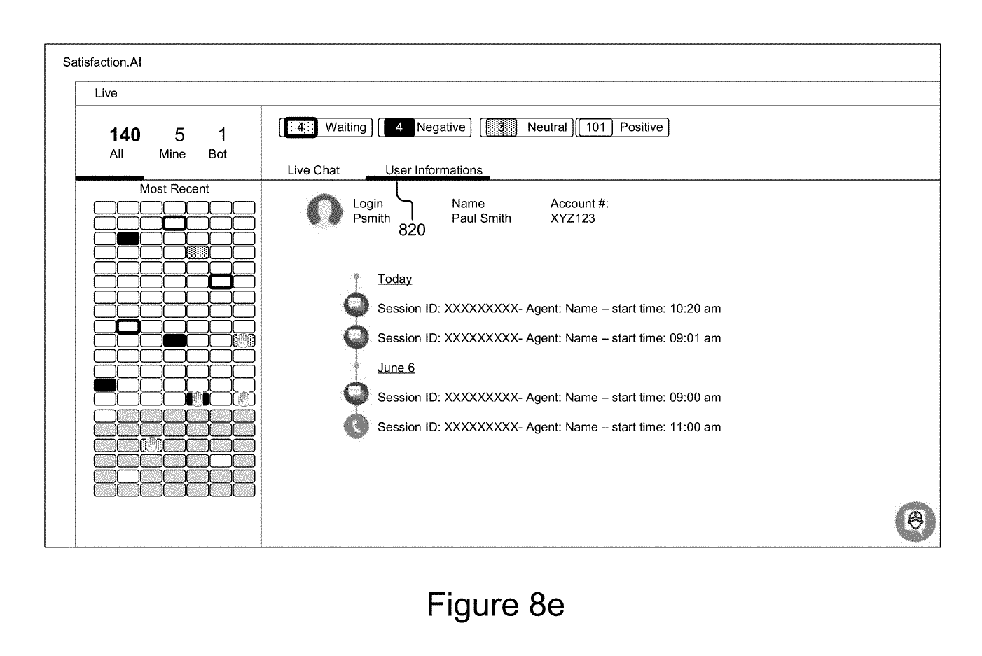

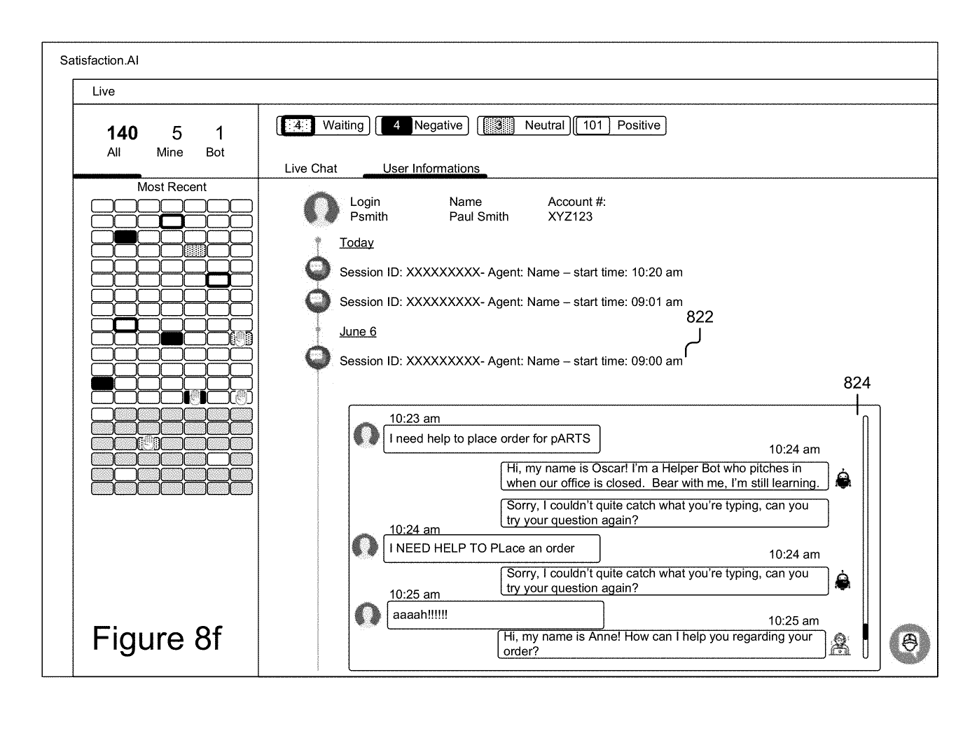

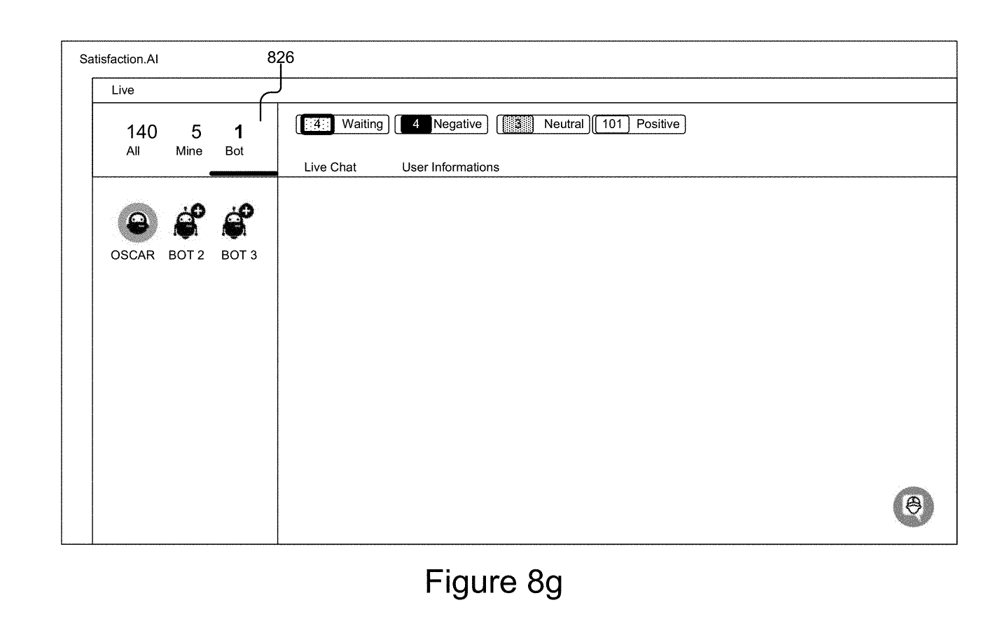

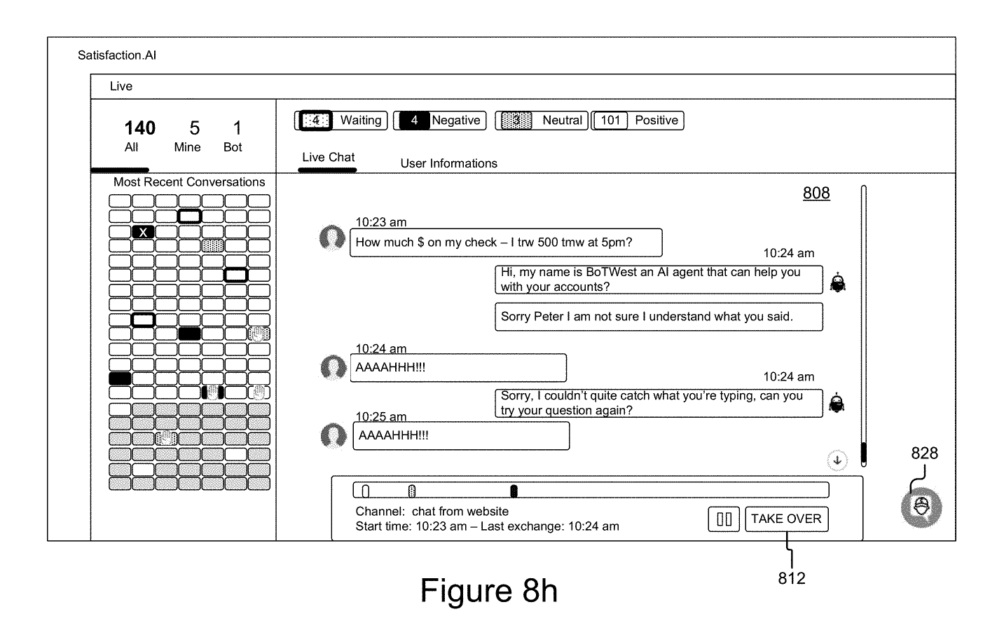

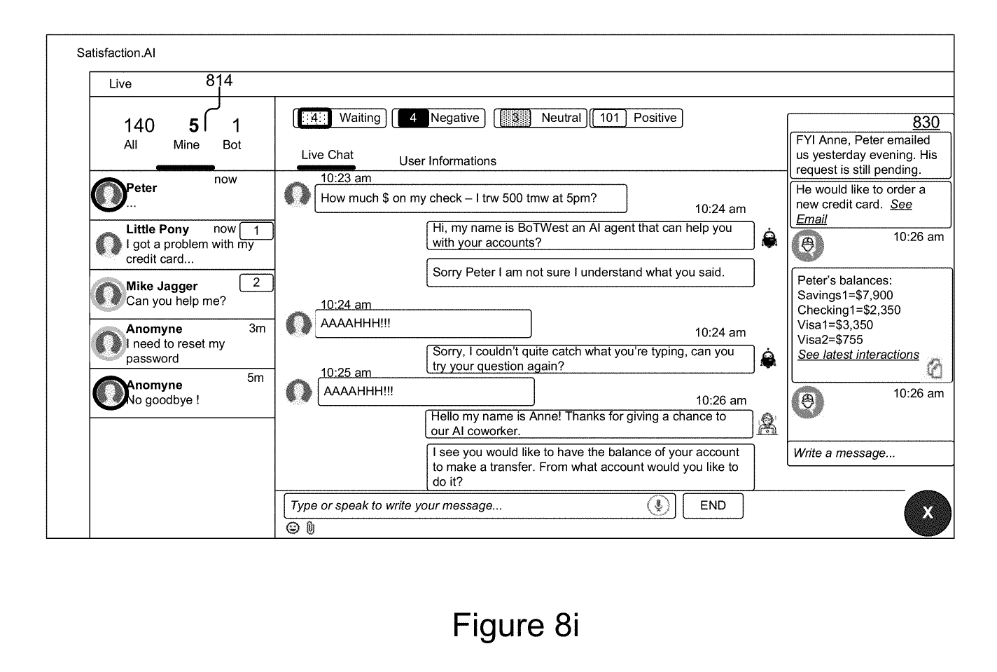

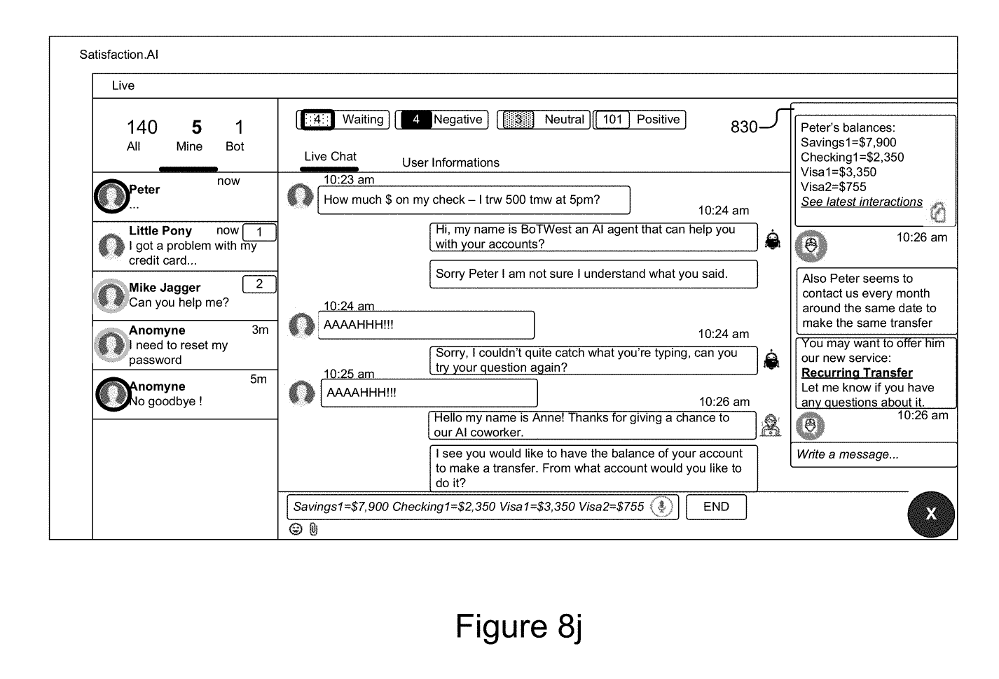

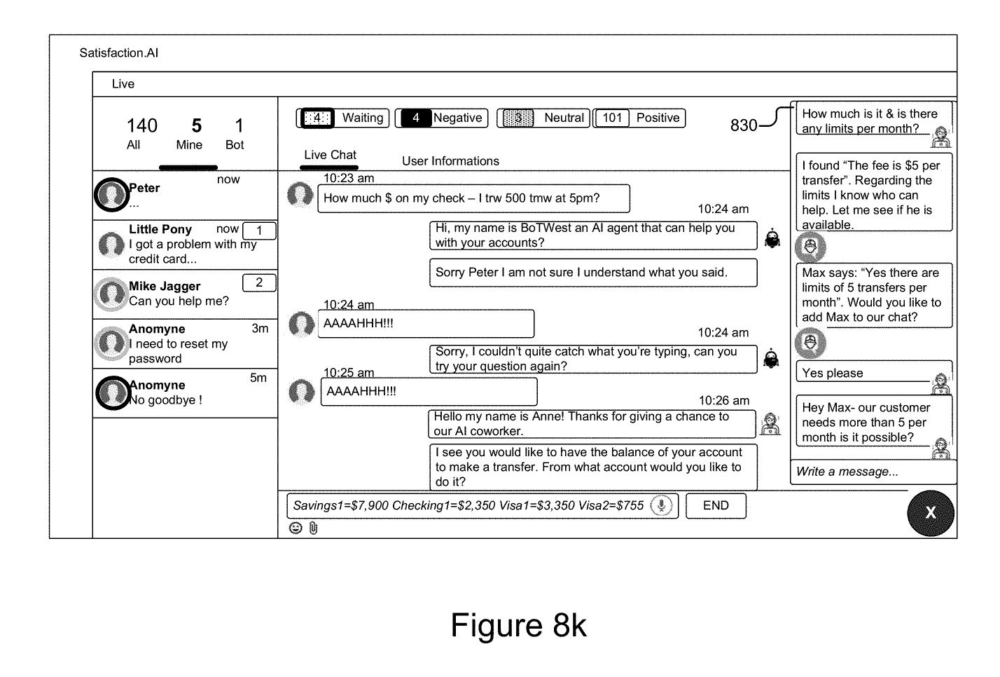

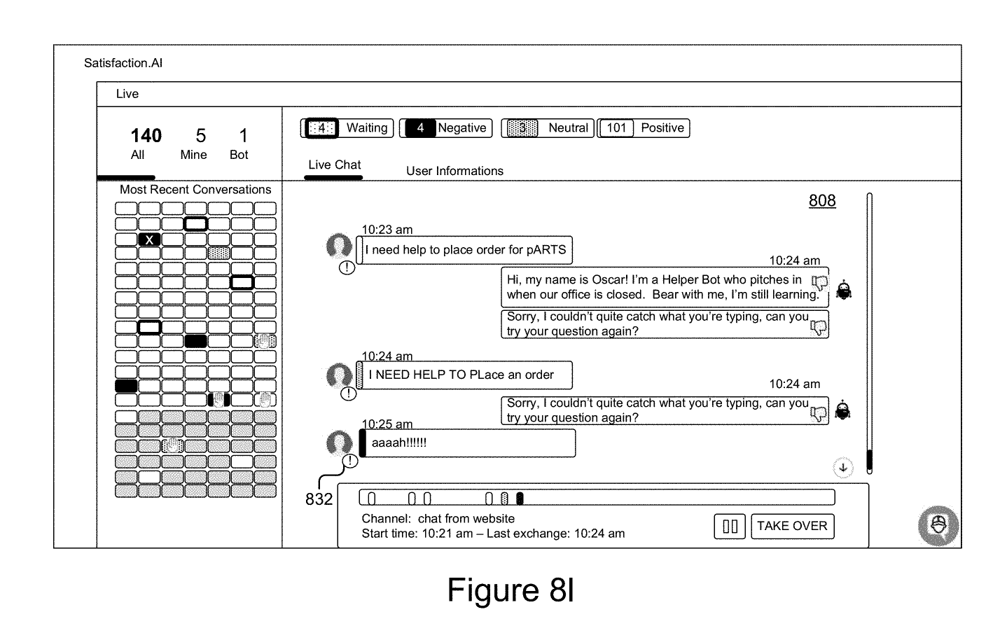

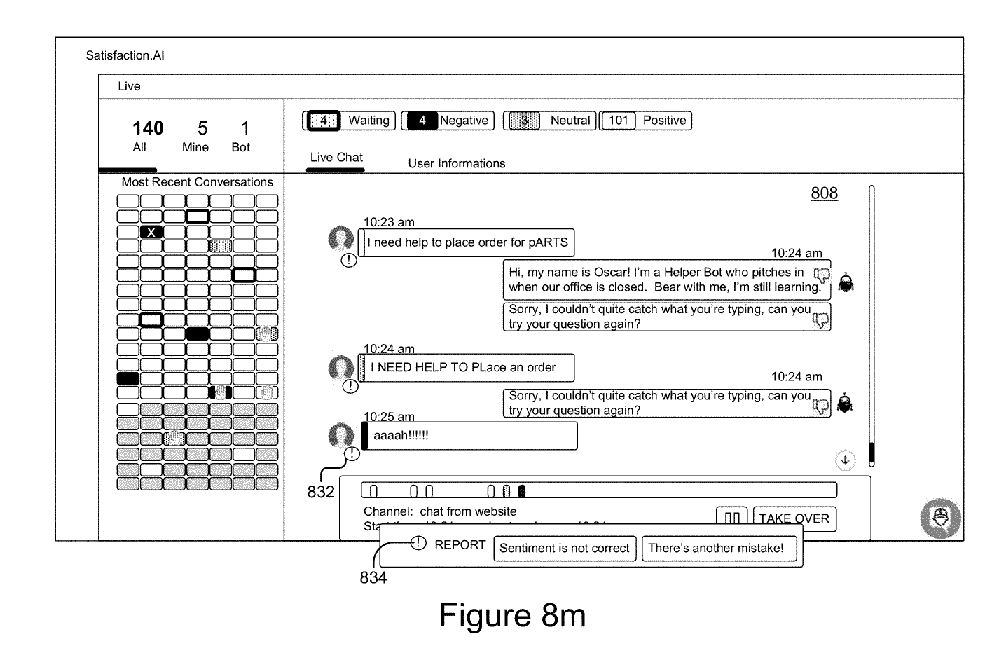

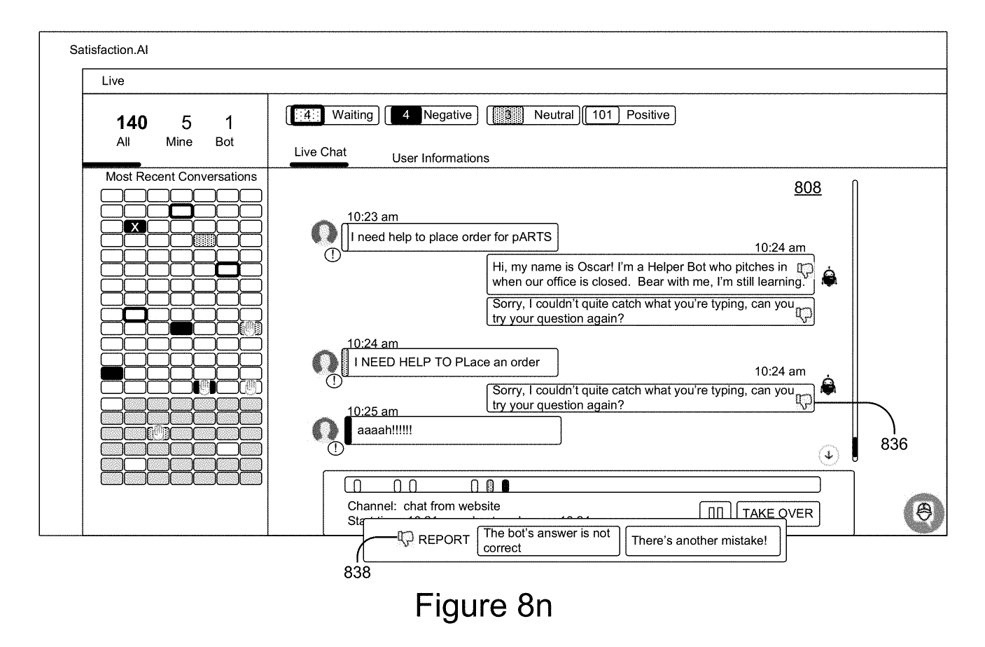

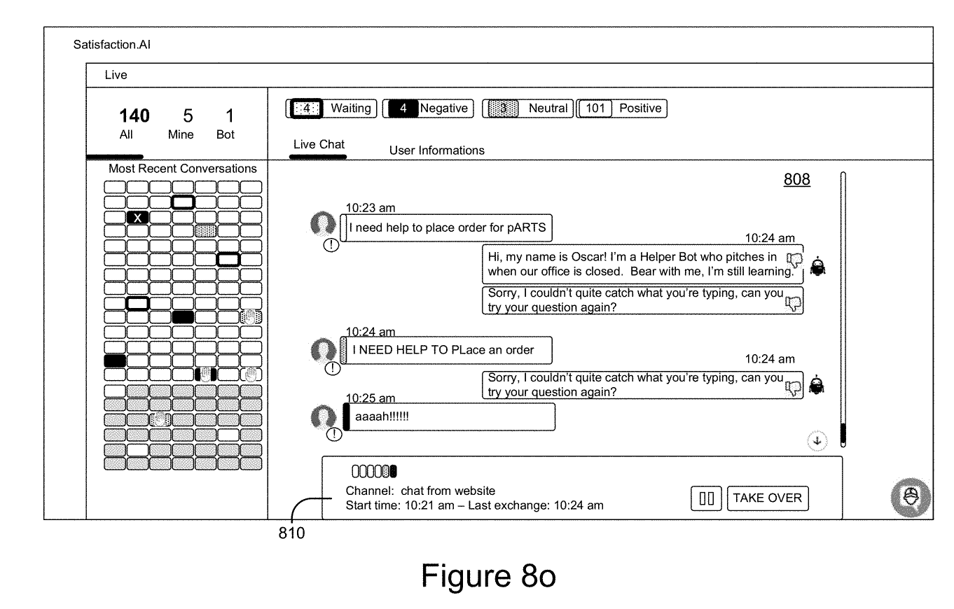

The agent engine 326 enables an agent to monitor the sessions within the system 100, or a subset of the sessions within the system 100, and intervene in a session (e.g. one in which the conversation is not going well based on the rank assigned by the conversation ranking engine 324). In one embodiment, the agent engine 326 generates graphical information for providing user interfaces to the agent, which allow the visualization of the on-going sessions, rank information (e.g. based on the rank assigned by the conversation ranking engine 324), which the agent may use to determine and visualize the sessions in which the agent should intervene. Example user interfaces, according to one embodiment, are discussed below with reference to FIGS. 8a-8o.

In some embodiments, once an agent has intervened in a session, the agent may answer the customer's questions, perform actions requested by the customer (e.g. opening an account, ordering an item, etc.), or perform other actions to serve the customer. The agent engine 326 allows an agent to end a session in which he/she has intervened. In one embodiment, the agent's ending of the session does not terminate the session, but ends the agent's participation in the session, e.g., the session may continue with the customer and the chatbot.

The coach engine 328 is an AI engine 322 designed to help and support the human agent. For example, the coach engine 328 may provide information (e.g. customer's current balances) and/or suggestions (e.g. to set up a recurring transfer based on patterns in the customer's behavior) to an agent who has intervened in a session or answer questions the agent may have (e.g. how to perform an action requested or whether it involves a fee). In one embodiment, the coach engine 328 may determine that it does not have the knowledge to answer an agent's question, but may determine that an individual (e.g. a supervisor or agent that has a specialty) may have that information and may refer the agent to that individual (e.g. via a side-bar window using the supervisor engine 330).

The supervisor engine 330 enables an individual (e.g. a supervisor, a more senior agent, or specialist, or other agent) and the agent to interact in a side-bar (e.g. side conversation via separate chat window or phone call) so that the agent may better assist the customer.

The error engine 332 enables an agent to identify errors in the system 100. Examples of errors may include incorrect answers from the chatbot, incorrect identification of the sentiment of an interaction, etc. In one embodiment, the error engine 332 includes the capability to generate a disambiguation before activating an error, reformulate the customer question, ask for more details to define the final meaning of the customer query, or some combination of the foregoing.

In one embodiment, the error engine 332 includes a suite of tools (not shown) to help the trainer of the machine to identify errors in the training and to fix the errors or otherwise improve the training of the AI/chatbot. In one embodiment, the error engine 332 may perform one or more of identify a source of error in the prediction, identify potential errors, indicate a source of the error (e.g. that the error may be attributed to misidentification of intent and/or that multiple intents are similar, which may cause confusion in identification by the chatbot), prompt the trainer to remove example prompts (e.g. sentences) associated with an intent to reduce overfitting, prompt the user to provide additional and/or varied prompts for an intent (e.g. by displaying intents with low variety), identify sentences that are matched to intent(s) at a low rate for evaluation and classification by the trainer.

In some embodiments, the identified errors are used to improve (e.g. train) the AI engine 322 and or conversation ranking engine 324 so that the AI engine 322 improves over time and may provide better answers in the future and/or the conversation ranking engine 324 may better identify problematic sessions/conversations in the future.

### Example Methods

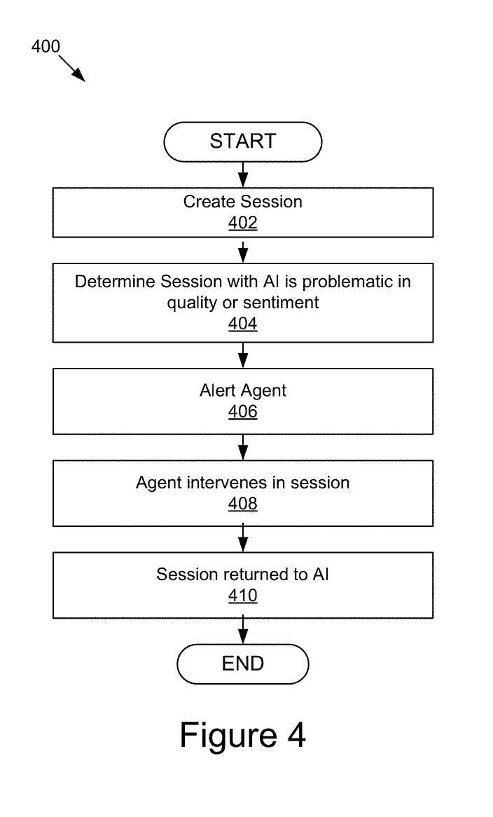

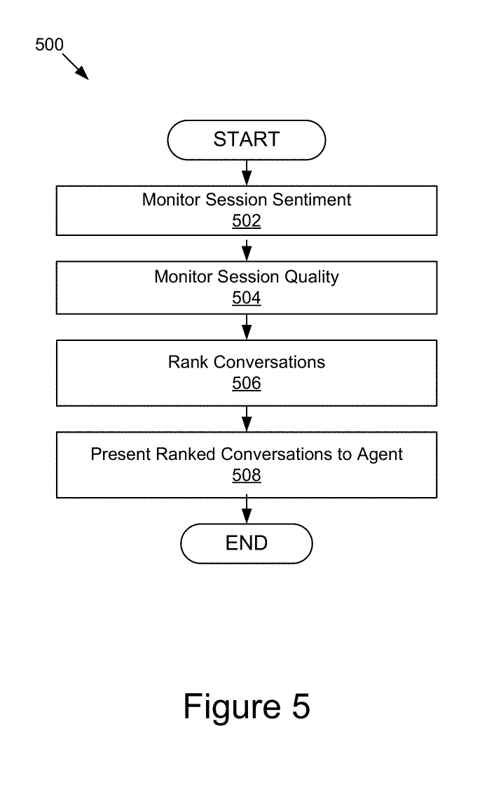

FIGS. 4 and 5 depict methods 400 and 500 performed by the system described above in reference to FIGS. 1-3.

Referring to FIG. 4, an example method 400 for session handling using conversation ranking and augmented agents according to one embodiment is shown. At block 402, the AI engine 322 creates session. At block 404, the conversation ranking engine 324 determines based on a ranking of quality and/or sentiment that the session with the AI chatbot is problematic. At block 406, the agent engine 326 alerts the agent and the agent, at block 408, intervenes in the session via the agent engine 326. At block 410, the agent engine 326 returns the session to the AI engine 322.

Referring to FIG. 5, an example method 500 for conversation ranking according to one embodiment is shown. At block 502, the conversation ranking engine 324 monitors the sentiment and, at block 504, the quality of a session. At block 506, the conversation ranking engine 324 ranks the conversation, e.g., relative to other ongoing sessions and/or previous sessions. At block 508, the conversation ranking engine 324 presents the ranked conversations to an agent.

In one embodiment, the rank uses a weighted average. For example, in one embodiment, an accuracy for each parameter, e.g., the sentiment analysis, distribution of words per sentence and/or conversations, number of utterances in the conversation regarding the whole conversation of the same agent, etc. Depending on the embodiment, the computing of accuracy can be through an artificial neural network or simple linear algebra calculation, e.g., vectors distances. In one embodiment, one or more of the parameter is then normalized as a percentage. In one embodiment, a parameter receives a weight to calculate the average accuracy of the conversation. In some embodiments, the weight can be defined as a parameter in the system 100 or another type of artificial neural network is trained to define, through regression, what the best weight distribution for parameters is based on a small number of weights defined by a team in charge to train the system 100.

It should be noted that the methods are merely examples and the other methods are contemplated and within the scope of this disclosure. For example, the methods may include more, different or fewer blocks; the blocks may vary in order or be perform in parallel (e.g. blocks 502 and 504 may be sequential or parallel).

### Example Illustrations and UIs

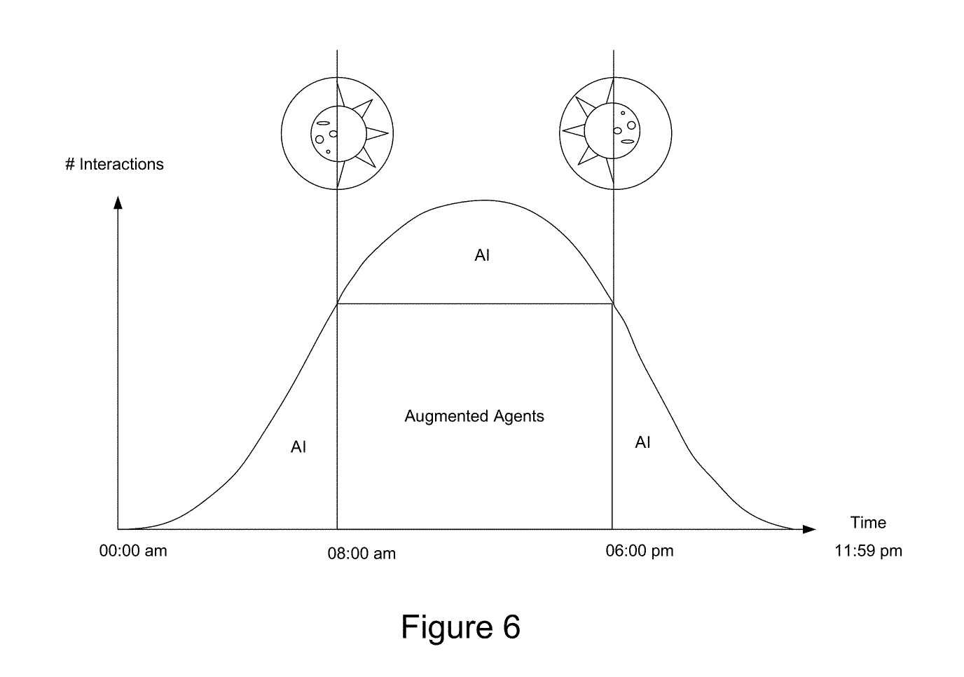

FIG. 6 is a diagram describing an example of augmented session handling according to one embodiment. In the illustrated embodiment of FIG. 6, sessions are handled exclusively by AI outside of call center hours (i.e. 6 PM to 8 AM in the illustrated example). During the call center's hours, the AI and Augmented agents handle sessions. It should be recognized that, using the augmented agents, systems and methods herein, leverages AI to service more calls than a given number of agents would be able to handle alone, and improves customer experience by identifying sessions which are not going well with the AI and allowing a human agent to intervene.

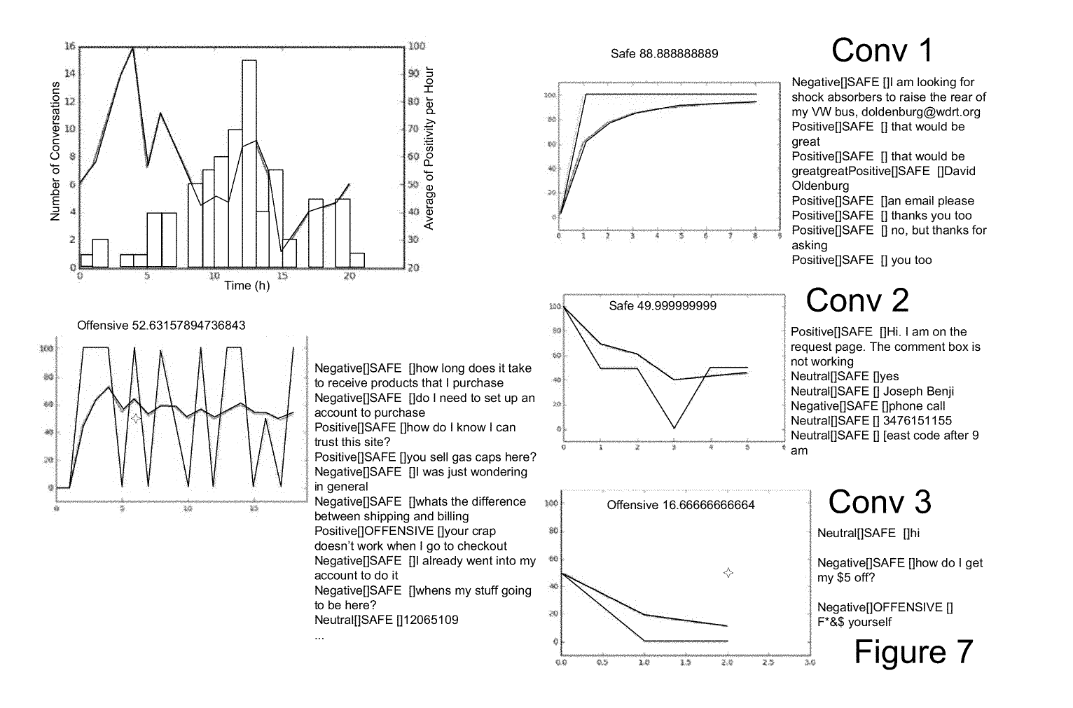

FIG. 7 depicts various example graphs associated with the system according to one embodiment. For example, the upper, left graph includes a bar chart of the conversations/sessions in each hour of the day (bar charts) with a line overlaid indicating the “average positivity” of conversations throughout the day. The right column shows three conversations and the sentiment in those conversations as the conversations progress. More specifically, Conv 1 displays a conversation that is trending and is currently positive (as determined by the conversation ranking engine 324). Conv 2 displays a conversation that is trending negatively but is currently neutral (as determined by the conversation ranking engine 324). Conv 3 displays a conversation that is trending negatively and is currently negative (as determined by the conversation ranking engine 324). In each of the conversations, Conv1-3, each customer interaction (i.e. input of what the customer said or typed) is assigned a positive, neutral, or negative sentiment. In one embodiment, these sentiments are assigned by the conversation ranking engine 324 and used to rank the conversations.

FIGS. 8a-o are example user interfaces presented to a human agent according to one embodiment of the system described above in reference to FIGS. 1-3. In FIG. 8A, the “All” tab 802, which indicates that 140 sessions are in progress is selected. In one embodiment, the grid 804 includes a visual indicator for each of those sessions. A visual indicator for a session may be arranged within the grid relative to other visual indicators associated with other sessions based on one or more criteria. For example, the indicators in the grid may be arranged based on ranking (e.g. so that the conversations that are determined to be going poorly are located in proximity, such as near the top of the UI). In another example, the indicators in the grid may be arranged based on age (e.g. so that the sessions are ordered oldest to newest in the bar 810). In another example, the indicators in the grid may be arranged based on whether an agent has intervened or is intervening (e.g. so that indicators associated with such sessions are located within proximity to one another within bar 810). In another example, the indicators in the grid may be arranged based on channel (e.g. so that sessions associated with SMS are visually grouped, sessions associated with phone calls are visually grouped, and sessions associated with e-mail are visually grouped).

In one embodiment, the visual indicator varies based on how the session is going (as determined by the conversation ranking engine 324). For example, different colors may be assigned by the conversation ranking engine 324 to indicate the session's rank. The sessions rank indicates whether the session is going well (positive), poorly (negative), neutral, as determined by the conversation ranking engine 324. A session may also be indicated as waiting by the conversation ranking engine 324 (e.g. indicating a human agent has been requested by a customer bypassing interaction with the chatbot in whole or in part). The user interface may visually indicate which chatbot is handling the session. In one embodiment, the visual indicator(s) illustrated herein may vary in design based on status including current ranking (e.g. changes color as ranking becomes negative), whether an agent has intervened (e.g. an icon with a hand on it indicates current or historic, depending on the embodiment, human agent intervention in the session), etc.

In FIG. 8b, session element 806 of the grid has been selected, which is indicated by the visual distinction, which is illustrated as an X on the session element 806. Responsive to the selection of session element 806, portion 808 of the UI is updated, by the agent engine 326, to display the conversation associated with that session. Bar 810, indicates how each customer interaction in the conversation was ranked by the conversation ranking engine 324 (e.g. using sentiment analysis). The indicators within Bar 810 and/or the color of the speech bubbles in portion 808 may be color coded based, e.g., on the sentiment of the associated interaction as determined by the conversation ranking engine 324. It can be seen that “I NEED HELP TO Place an order” is “neutral,” as determined by the conversation ranking engine 324, rather than positive perhaps in part due to the capitalization and that it was repetitive with what the customer said previously, and the “aaaah! !! !” is negative perhaps because of the exclamation points and indication of frustration “Ah” has. The human agent may decide to intervene by selecting the “TAKE OVER” 812 graphical element.

In FIG. 8c, the “TAKE OVER” 812 graphical element was selected and portion 808 indicates that the human agent has introduced herself and the user has requested help with an order and driveshaft center support. FIG. 8c also illustrates that this UI is under the “Mine” tab 814 and that the agent is currently participating in 5 sessions.

In FIG. 8d, the “END” 816 graphical element was selected by the agent (e.g. after answering the customer's questions (not shown)), and window 818 is displayed indicating that the session will be returned to the bot and asks for confirmation from the agent.

In FIG. 8e, the “User Information” tab is selected. The tab includes user account information (e.g. login name, name, and account number) and a log of sessions with the customer.

In FIG. 8f, session 822 has been selected by the agent and window 824 shows the conversation/content of that session.

In FIG. 8g, the “Bot” tab 826 has been selected. The UI shows three bots of which one, OSCAR, is selected. Depending on the embodiment, the bots may be associated with different departments within the same company or different companies altogether (e.g. when the agent works for a call center that takes customer service calls on behalf of multiple companies or departments of a large company).

FIG. 8h illustrates a session that is not going well (i.e. negative as determined by the conversation ranking engine 324) and has been selected for view by the agent. The agent selects the “TAKE OVER” 812 graphic element and the coach element 828. Subsequently, FIG. 8i is presented to the agent, which includes the coach sidebar 830, in which a chatbot for supporting and assisting the agent is available in the illustrated embodiment. As illustrated, the coach chatbot has provided additional information about the customer, Peter, a recent request, current balances and, in FIG. 8j, a pattern of behavior for Peter and a suggested service (recurring transfer) to offer Peter. In FIG. 8k, the agent has asked the coach chatbot about fees and limits. The coach chatbot was able to answer regarding the fee, but did not have an answer regarding limits, so identified, to the agent, the individual “Max Apple” as potentially knowing the answer as to limits, asked Max Apple and provided the response to the agent. The coach bot also offered to include Max in the conversation of sidebar 830 and did so at the agent's request. In illustrated embodiment of FIGS. 8i-k, the chatbots contributions to the session are identified using a visual indicator (i.e. the robot icon in the text bubble), and the agent's contributions to the sessions are identified using another visual indicator (i.e. the person icon in the latter text bubbles). It should be recognized that these visual indicators are merely examples and that other indicators may be used without departing from the disclosure herein.

FIGS. 8l-n disclose error identification. In FIG. 8l, the user may select element 832 associated with an interaction. Responsively, as illustrated in FIG. 8m, window 834 is displayed in which the user may select an element indicating the type of error (e.g. sentiment or other). In some embodiments additional interfaces may allow the user to correct the mistake or indicate what the correct sentiment is, which may be used to train the ranking algorithm(s) of the conversation ranking engine 324. In FIG. 8n, element 836 was selected by the agent and window 838 is displayed in which the user may select an element indicating the type of error (e.g. bot's answer incorrect or other). In some embodiments additional interfaces may allow the user to provide the correct answer, which may be used to train the AI engine 322 so that the chatbot becomes more capable.

FIG. 8o illustrates a different representation of the bar 810 illustrating interactions within the session and associated sentiments, which reduces the space between each block in bar 810, where each block is associated with a customer input to the session and color coded according to the sentiment associated with that input (e.g. as determined by the conversation ranking engine).

While not illustrated in FIGS. 8a-o, some of the UIs of Appendix C include indicators identifying a source channel (e.g. whether communication/conversation uses Skype, Facebook, phone, e-mail, etc.).

### Other Considerations

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

Reference in the specification to “one embodiment” or “an embodiment” or “one implementation” or “an implementation” means that a particular feature, structure, or characteristic described in connection with the embodiment, or implementation, is included in at least one embodiment or implementation. The appearances of the phrase “in one embodiment” or “in one implementation” in various places in the specification are not necessarily all referring to the same embodiment or implementation.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of an entirely hardware implementation, an entirely software implementation, or implementations containing both hardware and software elements. For instance, the technology may be implemented in software, which includes but is not limited to firmware, resident software, microcode, etc.

Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code may be be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi′) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the method blocks. The structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As should be understood, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats. Furthermore, the engines, modules, routines, features, attributes, methodologies and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A method comprising:
receiving, using one or more processors, user input from a human user in a communication session between the human user and a first machine;
autonomously determining, using the one or more processors, a sentiment metric of the user input from the human user based on one or more sentiment criteria, wherein the sentiment metric represents an attitude of the human user;
autonomously determining, using the one or more processors, a quality metric associated with the communication session;
autonomously ranking, using the one or more processors, the communication session between human user and first machine based on one or more of the sentiment metric and the quality metric; and
determining, using the one or more processors, based on the ranking, to recommend human agent intervention in the communication session between the human user and the first machine.

2. The method of claim 1, wherein the first machine includes an artificial intelligence, or a virtual assistant, or a chatbot.

3. The method of claim 1, wherein the sentiment metric of the user input is determined based on one or more of a single human user input in the communication session, a set of multiple human user inputs during the communication session, and a trend of sentiment during the communication session.

4. The method of claim 1, wherein the sentiment metric is determined based on one or more of presence of offensive language, emojis usage, punctuation usage, font style, use of letter capitalization, vocal analysis, explicit request by the human user for a human, spelling mistakes, rapidity of response, repetition of input by the human user.

5. The method of claim 1, wherein the quality metric is a numeric value associated with one or more of a confidence of the first machine in an intent of the human user, as determined by the first machine, and a confidence of the first machine in an answer determined in response to the user input and the intent of the human user as determined by the first machine.

6. The method of claim 1, wherein determination of the sentiment metric, the quality metric, and the ranking are performed responsive to receipt of the user input from the human user, and re-performed after a subsequent input is received from the human user.

7. The method of claim 1, comprising:
visually indicating within a graphical user interface that intervention by a human agent is recommended for the communication session based on the ranking, the graphical user interface presented to the human agent; and
receiving input from the human agent requesting intervention in the communication session.

8. The method of claim 7, wherein the graphical user interface includes a plurality of session indicators including a first session indicator associated with the communication session.

9. The method of claim 1, comprising:
receiving input from a human agent requesting assistance from a second machine;
initiating a second communication session with the second machine; and
providing a graphical user interface including a first portion displaying input of the human user, first machine, and human agent, and a second portion displaying a communication session between the human agent and the second machine.

10. The method of claim 1, comprising:
receiving a request, on behalf of the human agent, to end intervention by the human agent, wherein, responsive to receiving the request to end intervention by the human agent, the communication session continues between the human user and the first machine.

11. A system comprising:
one or more processors; and
a memory storing instructions that, when executed by the one or more processors, cause the system to:
receive user input from a human user in a communication session between the human user and a first machine;
autonomously determine a sentiment metric of the user input from the human user based on one or more sentiment criteria, wherein the sentiment metric represents an attitude of the human user;
autonomously determine a quality metric associated with the communication session;
autonomously rank the communication session between human user and first machine based on one or more of the sentiment metric and the quality metric; and
determine based on the ranking, to recommend human agent intervention in the communication session between the human user and the first machine.

12. The system of claim 11, wherein the first machine includes an artificial intelligence, or a virtual assistant, or a chatbot.

13. The system of claim 11, wherein the sentiment metric of the user input is determined based on one or more of a single human user input in the communication session, a set of multiple human user inputs during the communication session, and a trend of sentiment during the communication session.

14. The system of claim 11, wherein the sentiment metric is determined based on one or more of presence of offensive language, emojis usage, punctuation usage, font style, use of letter capitalization, vocal analysis, explicit request by the human user for a human, spelling mistakes, rapidity of response, repetition of input by the human user.

15. The system of claim 11, wherein the quality metric is a numeric value associated with one or more of a confidence of the first machine in an intent of the human user, as determined by the first machine, and a confidence of the first machine in an answer determined in response to the user input and the intent of the human user as determined by the first machine.

16. The system of claim 11, wherein determination of the sentiment metric, the quality metric, and the ranking are performed responsive to receipt of the user input from the human user, and re-performed after a subsequent input is received from the human user.

17. The system of claim 11, wherein the system is further configured to:
visually indicate within a graphical user interface that intervention by a human agent is recommended for the communication session based on the ranking, the graphical user interface presented to the human agent; and
receive input from the human agent requesting intervention in the communication session.

18. The system of claim 17, wherein the graphical user interface includes a plurality of session indicators including a first session indicator associated with the communication session.

19. The system of claim 11, wherein the system is further configured to:
receive input from a human agent requesting assistance from a second machine;
initiate a second communication session with the second machine; and
provide a graphical user interface including a first portion displaying input of the human user, first machine, and human agent, and a second portion displaying a communication session between the human agent and the second machine.

20. The system of claim 11, c wherein the system is further configured to:
receive a request, on behalf of the human agent, to end intervention by the human agent, wherein, responsive to receiving the request to end intervention by the human agent, the communication session continues between the human user and the first machine.
